(19) United States
(12) Patent Application Publication
(10) Pub. No.: US 2007/0295365 A1
(43) Pub. Date: Dec. 27, 2007

(54) SUBSTRATE PROCESSING METHOD AND SUBSTRATE PROCESSING APPARATUS

(76) Inventors: Katsuhiko Miya, Kyoto (JP); Akira Izumi, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/767,902

(22) Filed: Jun. 25, 2007

(30) Foreign Application Priority Data
Jun. 27, 2006 (JP) 2006-176472
Sep. 13, 2006 (JP) 2006-247923

(51) Int. Cl. B08B 3/00; B08B 7/00

(52) U.S. Cl. 134/26; 134/33; 134/137; 134/94.1; 134/95.2

(57) ABSTRACT

After rinsing, while rotating a substrate, a front layer part of a rinsing liquid (DIW) adhering to a substrate surface is drained and removed from the substrate surface. This is followed by supply to the substrate surface of a liquid mixture which is obtained by mixing IPA and DIW together. Since a majority of the rinsing liquid on the substrate surface is removed off from the substrate surface, even when micro patterns are formed on the substrate surface, the liquid mixture replaces the liquid component adhering to the gaps between the patterns. Further, the IPA concentration in the liquid mixture supplied to the substrate surface is set to 50% or below. Hence, it is possible to effectively prevent destruction of the patterns while suppressing the consumption amount of

### CROSS REFERENCE TO RELATED APPLICATION

The disclosure of Japanese Patent Applications No. 2006-176472 filed Jun. 27, 2006 and No. 2006-247923 filed Sep. 13, 2006 including specification, drawings and claims is incorporated herein by reference in its entirety.

### BACKGROUND OF THE INVENTION

1. Field of the Invention

The present invention relates to a substrate processing method of and a substrate processing apparatus for drying a surface of a substrate which is wet with a liquid. Substrates to be dried include semiconductor wafers, glass substrates for photomask, glass substrates for liquid crystal display, glass substrates for plasma display, substrates for optical disks, etc.

2. Description of the Related Art

Numerous drying methods have already been proposed which aim at removal of a rinsing liquid adhering to a surface of a substrate after chemical processing using a chemical solution and rinsing processing using a rinsing liquid which may be deionized water or the like. Known as one such method is a drying method which uses an organic solvent component such as IPA (isopropyl alcohol). In relation to a substrate processing apparatus of a single wafer type in particular, the so-called Rotagoni drying is known which is a combination of spin drying and drying processing which utilizes a convective flow (Marangoni effect) generated due to a difference in surface tension between deionized water and IPA.

In the Rotagoni drying, IPA (isopropyl alcohol) vapor and deionized water are discharged respectively from associated nozzles upon a rotating substrate from above the center of the substrate. Drying starts in an area provided with the IPA vapor, and as these nozzles gradually move toward outside in the radial direction of the substrate, the dried region spreads from the center of the substrate toward the rim thereof, and then the entire substrate is dried. In short, the deionized water on the substrate is removed off from the substrate due to the function of centrifugal force attributed to the rotation of the substrate and the Marangoni effect caused by discharging of the IPA vapor, whereby the substrate is dried.

As other substrate drying method which uses IPA, a drying method described in JP-A-2003-168668 is known. A substrate processing apparatus which executes this drying method is an apparatus which spin-dries a substrate after chemical processing and rinsing processing of the substrate. In this apparatus, chemical processing is followed by rinsing processing during which a dual-fluid mixing nozzle supplies to a substrate a nitrogen gas and IPA-contained deionized water which is prepared by mixing IPA with deionized water. This removes a chemical solution and particles adhering to a surface of the substrate, and suppresses generation of watermarks on the substrate surface during drying.

Further, in a substrate processing apparatus described in JP-A-7-122485, an IPA solution which is obtained by mixing IPA with deionized water is supplied to a substrate after development, whereby rinsing processing is performed. This makes it possible to execute rinsing processing while preventing destruction of micro resist patterns.

Further, in the cleaning apparatus described in JP-A-9-38595, after hydrofluoric acid treatment of a surface of a substrate, deionized water is supplied to the substrate surface and cleaning processing (rinsing processing) is accordingly attained. Following this, IPA is supplied to the substrate surface without any break after the end of the supply of deionized water or from the middle of the supply of deionized water. In consequence, IPA is dissolved in deionized water which is present on the substrate surface, and replaces deionized water. The replacement of deionized water on the substrate surface with IPA prevents generation of watermarks during drying of the substrate.

Further, according to a resist developing method described in JP-A-3-209715, the amount of micro foreign matters present on the substrate surface is reduced in the following manner. First, deionized water is supplied to the substrate after development of a resist, thereby performing deionized water cleaning (rinsing processing). After this, deionized water containing IPA at the capacity ratio of about 10% (IPA solution) is supplied to the substrate, whereby the substrate is cleaned. This is followed by spin drying of the substrate while rotating the substrate at a high speed.

### SUMMARY OF THE INVENTION

By the way, while patterns formed on a surface of a substrate have become increasingly finer at a rapid pace over the recent years, this pattern miniaturization has led to a new problem during substrate processing. Namely, the problem that micro patterns pull each other and collapse during execution of drying processing. Describing this in more specific details, an interface between a liquid and a gas appears on a substrate with a progress of drying, and when the interface appears in a gap between the micro patterns, the negative pressure developing in gaps between patterns pull micro patterns to each other and make them collapse. The magnitude of the negative pressure developing in the gaps between the patterns is dependent upon the surface tension of the liquid, and the larger the surface tension of the liquid is, the larger the negative pressure is. Hence, for drying of a surface of a substrate wet with deionized water while effectively preventing destruction of patterns, it is necessary to use a fluid whose surface tension is smaller than that of deionized water, which may for instance be an organic solvent component such as IPA, and feed IPA even into the gaps between the patterns.

However, Rotagoni drying gives rise to the following problem since a substrate is dried while rotating the substrate. In short, even though IPA vapor is supplied to a surface of the substrate, IPA vapor is discharged immediately from the substrate due to the influence of an air flow which develops as the substrate rotates, and it is not therefore possible to sufficiently dissolve IPA in deionized water which adheres to the substrate surface. As a result, the substrate surface is dried before IPA is dissolved sufficiently in deionized water which adheres to the inside of the gaps between patterns which are formed on the substrate surface, and hence, pattern destruction could not be prevented satisfactorily.

Further, according to the drying method described in JP-A-2003-168668, after chemical processing, the chemical solution and the particles adhering to the substrate surface are removed using IPA-contained deionized water in which IPA has been mixed as a rinsing liquid. In a similar fashion, in the substrate processing apparatus described in JP-A-7-122485 as well, after development, a liquid developer which remains adhering to the resist patterns and the substrate surface is removed using the IPA solution as a rinsing liquid. This leaves a problem that for removal of a processing liquid (e.g., a chemical solution, a liquid developer, etc.) and unwanted substances adhering to the substrate surface, a comparable rinsing time is required and the consumption amount of IPA accordingly increases.

Further, while IPA contains particles to a certain extent, if the amount of supplied IPA to a substrate becomes large, the particles contained in IPA could build up on a substrate and contaminate the substrate, which is a problem.

In addition, the cleaning apparatuses described in JP-A-9-38595 and JP-A-3-209715, at the time of supplying IPA or the IPA solution to the substrate surface after rinsing processing, a relatively great amount of deionized water adheres to the substrate surface. Hence, if IPA or the IPA solution is supplied to the substrate surface in such a condition, IPA gets discharged from the substrate to outside before IPA gets dissolved sufficiently in deionized water which adheres to the inside of the gaps between the patterns which are formed on the substrate surface. This makes it impossible to sufficiently prevent destruction of the patterns and generation of watermarks during drying of the substrate.

The invention has been made in light of the problems addressed above, and accordingly aims at realization of favorable drying of a surface of a substrate while suppressing the consumption amount of an organic solvent component in a substrate processing method and a substrate processing apparatus which dry, using the organic solvent component such as IPA, the substrate surface which is wet with a liquid.

According to a first aspect of the present invention, there is provided a substrate processing method of drying a substrate surface which is wet with a liquid, the method comprising: a liquid removing step of removing a majority of the liquid adhering to the substrate surface from the substrate surface, leaving a part of the liquid; a replacing step of supplying a liquid mixture which is a mixture of a liquid, whose composition or principal component is the same as that of the liquid adhering to the substrate surface, and an organic solvent component which gets dissolved in the liquid and reduces the surface tension, to the surface of the substrate which is held approximately horizontally, thereby replacing a liquid component still remaining on the substrate surface even after the liquid removing step with the liquid mixture; and a drying step of removing the liquid mixture from the substrate surface after the replacing step and accordingly drying the substrate surface, wherein a percentage by volume of the organic solvent component contained in the liquid mixture is 50% or less.

According to a second aspect of the present invention, there is provided a substrate processing apparatus, comprising: a substrate holder which holds a substrate approximately horizontally in a condition that a substrate surface which is wet with a liquid is directed toward above; a liquid supplier which supplies to the surface of the substrate which is held by the substrate holder a liquid mixture which is a mixture of a liquid, whose composition or principal component is the same as that of a liquid adhering to the substrate surface, and an organic solvent component which gets dissolved in the liquid and reduces the surface tension; and a liquid remover which removes a majority of the liquid adhering to the substrate surface from the substrate surface, leaving a part of the liquid, wherein after the liquid is removed from the substrate surface by the liquid remover, the liquid supplier supplies to the substrate surface the liquid mixture in which a percentage by volume of the organic solvent component is 50% or less, thereby replacing a liquid component adhering to the substrate surface with the liquid mixture, then the liquid mixture is removed from the substrate surface and accordingly the substrate surface is dried.

Meanwhile, the “organic solvent component” used in the invention may be an alcohols organic solvent. While isopropyl alcohol, ethyl alcohol or methyl alcohol may be used in consideration of the safety, the price and the like, isopropyl alcohol (IPA) is particularly suitable.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a graph of the relationship between the IPA concentration and the surface tension γ.

FIG. 2 is a graph of the relationship between the IPA concentration and the contact angle θ.

FIG. 3 is a graph of the relationship between the IPA concentration and γ×cos θ.

FIG. 4 is a diagram showing a first embodiment of a substrate processing apparatus according to the invention.

FIG. 5 is a block diagram which shows a control configuration of the substrate processing apparatus which is shown in FIG. 4.

FIG. 6 is a flow chart which shows an operation of the substrate processing apparatus which is shown in FIG. 4.

FIG. 7 is a timing chart which shows the operation of the substrate processing apparatus which is shown in FIG. 4.

FIGS. 8A through 8C are schematic diagrams which show the operation of the substrate processing apparatus which is shown in FIG. 4.

FIGS. 9A and 9B are schematic diagrams which show the operation of the substrate processing apparatus which is shown in FIG. 4.

FIG. 10 is a diagram showing a second embodiment of a substrate processing apparatus according to the invention.

FIG. 11 is a block diagram which shows a control configuration of the substrate processing apparatus which is shown in FIG. 10.

FIG. 12 is a diagram showing a third embodiment of a substrate processing apparatus according to the invention.

FIG. 13 is a diagram showing a fourth embodiment of a substrate processing apparatus according to the invention.

FIG. 14 is a timing chart which shows an operation of the substrate processing apparatus which is shown in FIG. 13.

FIG. 15 is a diagram showing a fifth embodiment of a substrate processing apparatus according to the invention.

FIG. 16 is a timing chart which shows the operation of the substrate processing apparatus which is shown in FIG. 15.

### DETAILED DESCRIPTION OF THE PREFERRED EMBODIMENTS

<Relationship Between Organic Solvent Component Concentration and Force Causing Pattern Destruction>

The inventors of the invention conducted various experiments to investigate the influence of a change of an organic solvent component concentration over the force which causes destruction of patterns. Meanwhile, the organic solvent component concentration is a percentage by volume of the organic solvent component contained in a liquid mixture. And, the liquid mixture is a mixture of a liquid, whose composition or principal component is the same as that of the liquid adhering to a substrate surface, and an organic solvent component which gets dissolved in the liquid and reduces the surface tension.

As expressed by the formula (1), the force which causes pattern destruction during drying of the substrate (that is, the negative pressure which develops in the gaps between the patterns) is dependent upon the magnitude of the product of the surface tension γ of the liquid which adheres to the gaps between the patterns (hereinafter referred to simply as the “surface tension γ”) and a value cos θ corresponding to the contact angle θ between the substrate surface and the liquid (hereinafter referred to simply as the “contact angle θ”).

2γ×cos θ (1)

Noting this, the inventors of the invention evaluated the relationship between the organic solvent component concentration and the surface tension γ and the relationship between the organic solvent component concentration and the contact angle θ. In evaluating, the inventors used deionized water (DIW) as a liquid whose composition is the same as that of the liquid adhering to the substrate surface, used an isopropyl alcohol (IPA) liquid as the organic solvent component, mixed DIW with IPA, and produced the liquid mixture. The inventors then measured the surface tension γ and the contact angle θ while changing the percentage by volume (hereinafter referred to as the “IPA concentration”) of IPA contained in the liquid mixture (DIW+IPA).

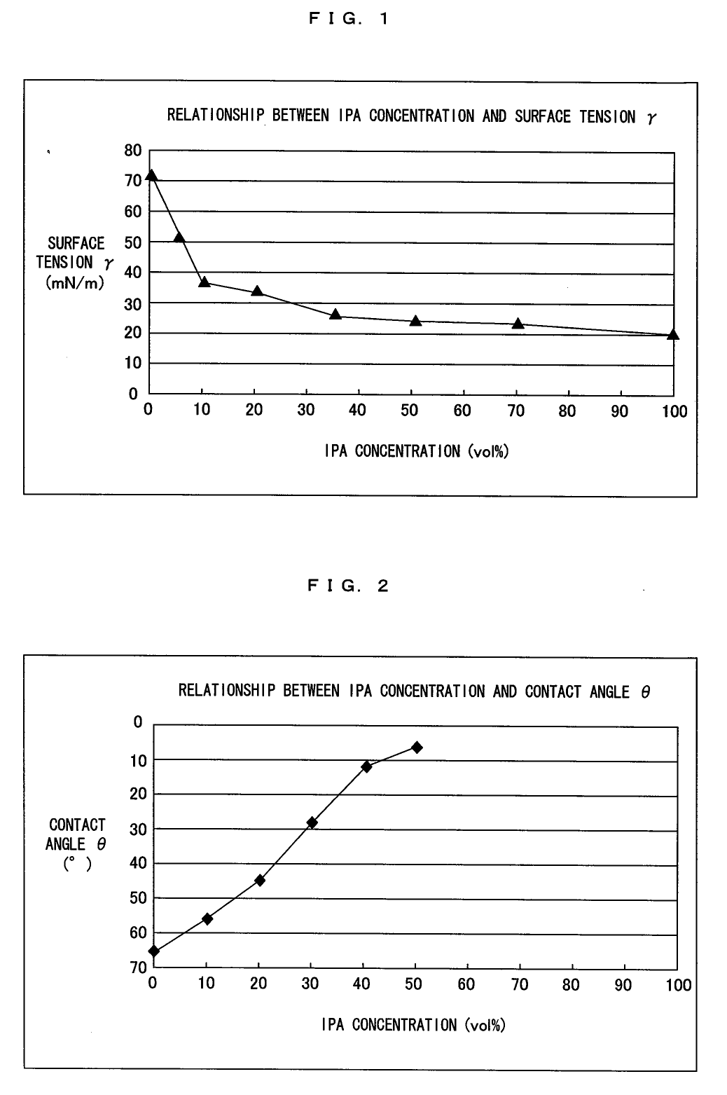

FIG. 1 is a graph of the relationship between the IPA concentration and the surface tension γ. FIG. 2 is a graph of the relationship between the IPA concentration and the contact angle θ. The horizontal axes in FIGS. 1 and 2 represent the IPA concentration. The IPA concentration of 0 (vol %) means that the liquid mixture is made only of DIW, whereas the IPA concentration of 100 (vol %) means that the liquid mixture is made only of the IPA liquid. The surface tension γ and the contact angle θ were measured using LCD-400S manufactured by Kyowa Interface Science Co., LTD. The surface tension γ was measured by the pendant drop method, while the contact angle θ was measured by the drop method. For measurement of the contact angle θ, a substrate which poly-Si was formed on the surface thereof was used, and the contact angle between the substrate surface which is processed with HF finally and the liquid (which was the liquid mixture, DIW alone or the IPA liquid alone).

As FIG. 1 clearly shows, in accordance with an increase of the mixed amount of IPA in DIW, up to the IPA concentration of around 10%, the surface tension γ of the liquid mixture rapidly decreases as the mixed amount of IPA in DIW increases. Where the IPA concentration is 50% or higher, the surface tension of the liquid mixture does not decrease significantly but maintains a value which is approximately equivalent to the surface tension of the IPA liquid alone. Meanwhile, in FIG. 2, as the mixed amount of IPA in DIW increases, the contact angle θ decreases approximately uniformly up to the IPA concentration of around 50%, and the rate at which the contact angle θ changes does not change much at the IPA concentration of around 10%. As the product of the surface tension γ and the value cos θ corresponding to the contact angle θ is calculated for each level of the IPA concentration, the relationship between the negative pressure developing in the gaps between the patterns (i.e., the force which causes destruction of the patterns) and the IPA concentration is identified.

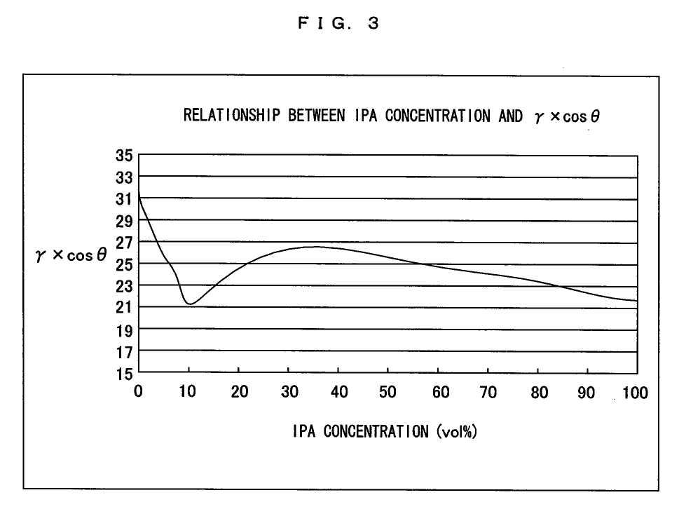

FIG. 3 is a graph of the relationship between the IPA concentration and γ×cos θ. As shown in FIG. 3, at the IPA concentration of around 10%, γ×cos θ, namely, the force which causes pattern destruction expressed by the formula (1) is minimum. This can be explained by the fact that as the mixed amount of IPA in DIW increases, up to the IPA concentration of around 10%, the contact angle θ does not decrease significantly although the surface tension γ of the liquid mixture drastically decreases. Further, one can see that γ×cos θ at the IPA concentration of around 10% is almost the same as γ×cos θ at the IPA concentration of 100%, i.e., γ×cos θ of the IPA liquid alone. It then follows that the force which causes pattern destruction remains unchanged regardless of whether the IPA liquid alone is used or the liquid mixture in which the IPA concentration is around 10% is used.

In terms of replacement of DIW adhering to the gaps between the patterns formed on the substrate surface with a substance whose surface tension is lower than that of DIW, it is important to supply a relatively great amount of the liquid mixture to the substrate while suppressing consumption of IPA.

To be more specific, in the case where the liquid adhering to the gaps between the patterns is replaced with the organic solvent component having the concentration of 100% using the organic solvent component having the concentration of 100%, it is necessary to supply the organic solvent component having the concentration of 100% to the substrate surface. Consequently, the consumption amount of the organic solvent component increases in proportion to the number of substrates to be processed. This leads to the requirement of a lot of the organic solvent component, which becomes a main cause of the cost increase. Therefore, it is not practical to use the organic solvent component having the concentration of 100%. On the other hand, in terms of suppressing the consumption amount of the organic solvent component, a method of supplying a comparatively little amount of organic solvent component to the substrate surface which is wet with the liquid and mixing the organic solvent component into the liquid before the drying step is a possibility. However, when the supplying amount of the organic solvent component per substrate is decreased, it is difficult to send the surface tension reducing substance (organic solvent component) into the gaps between the patterns and decrease the surface tension even if it is possible for the organic solvent component to get mixed with the front layer part of the liquid adhering to the substrate surface.

On the contrary, by supplying the liquid mixture in which a percentage by volume of the organic solvent component is 50% or less to the substrate, the liquid on the substrate is replaced with the liquid mixture as well as the liquid adhering to the gaps between the patterns with the liquid containing the surface tension reducing substance (liquid mixture). It is in this fashion possible to send the surface tension reducing substance into the gaps between the patterns and reduce the surface tension even without replacing processing which uses the organic solvent component (surface tension reducing substance) having the concentration of 100%. In this case, since the percentage by volume of the organic solvent component contained in the liquid mixture is 50% or below, the amount of the organic solvent component present in the gaps between the patterns is less than what would be present in replacing processing which uses the organic solvent component having the concentration of 100%. However, as the result of the experiment described above clearly shows, even when the percentage by volume of the organic solvent component contained in the liquid mixture is beyond 50%, the surface tension of the liquid mixture does not drop considerably, which means that one can not expect a significant reduction of the force destroying the patterns. On the contrary, this will give rise to a more influential disadvantage attributable to a restriction upon the amount of the liquid mixture supplied to the substrate due to the increased consumption amount of the organic solvent component described above. Hence, setting the percentage by volume of the organic solvent component contained in the liquid mixture to 50% or below realizes effective prevention of destruction of the patterns while suppressing the consumption amount of the organic solvent component.

Therefore, if the surface tension γ is smaller than that of DIW and the contact angle θ is larger than that of IPA, a lower IPA concentration is clearly advantageous from the viewpoint of effective prevention of pattern destruction. Noting this, the IPA concentration is preferably 50% or lower. In addition, since the force which causes pattern destruction decreases where the IPA concentration is around 10%, the IPA concentration is preferably from 5% to 35%, and more preferably, from 5% to 10%. Where the IPA concentration is set at such a concentration, it is possible to obtain the synergy between the effect of preventing pattern destruction realized by an increase of the amount of the liquid mixture supplied and the effect of preventing pattern destruction realized by a reduction of the force which causes pattern destruction, and hence, to effectively prevent pattern destruction. Although the experiments mentioned above used isopropyl alcohol (IPA) as the organic solvent component, similar pattern destruction preventing effects are basically obtainable even when ethyl alcohol or methyl alcohol is used.

The substrate processing method and the substrate processing apparatus according to the invention, using the liquid mixture having the composition described above, realize favorable drying of a substrate surface which is wet with a liquid while suppressing consumption of the organic solvent component. This will now be described in detail in relation to specific embodiments and with reference to the associated drawings.

### First Embodiment

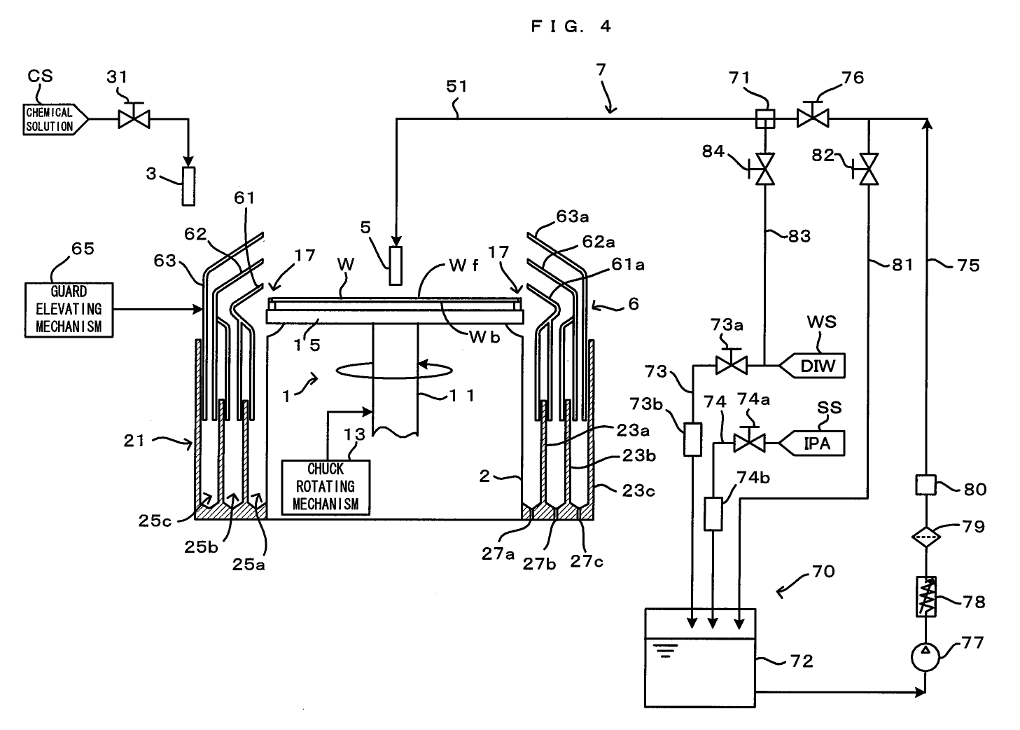

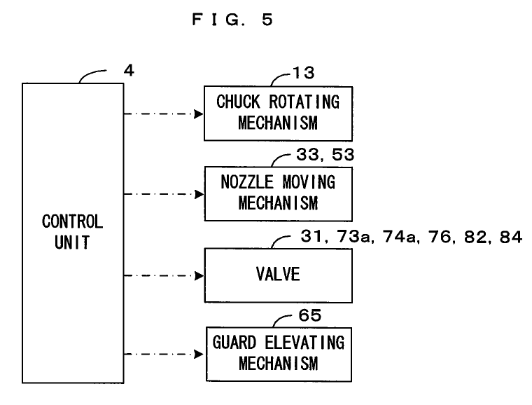

FIG. 4 is a diagram showing a first embodiment of a substrate processing apparatus according to the invention. FIG. 5 is a block diagram which shows a control configuration of the substrate processing apparatus which is shown in FIG. 4. This substrate processing apparatus is a substrate processing apparatus of the single wafer type which is used in cleaning processing which is for removing contaminants adhering to a surface Wf of a substrate W such as a semiconductor wafer. To be more exact, this is an apparatus in which after chemical processing with a chemical solution of a hydrofluoric acid or the like and rinsing processing with a rinsing liquid such as DIW of the surface Wf of the substrate W of which micro patterns of poly-Si are formed on the surface Wf, the substrate W wet with the rinsing liquid is subjected to replacing processing which will be described later, and the substrate W is dried.

This substrate processing apparatus comprises a spin chuck 1 which holds and rotates the substrate W approximately horizontally in a condition that the surface Wf is directed toward above, a chemical solution nozzle 3 and a rinse nozzle 5 which supply the chemical solution and the rinsing liquid respectively from above the substrate W which is held by the spin chuck 1. The rinse nozzle 5 is capable of selectively supplying DIW as the rinsing liquid and a liquid mixture to the substrate W, the liquid mixture being obtained by mixing a liquid whose composition is the same as that of the liquid (DIW) adhering to the substrate surface Wf after rinsing with the organic solvent component which gets dissolved in this liquid and reduces the surface tension.

A rotation column 11 of the spin chuck 1 is linked to a rotation shaft of a chuck rotating mechanism 13 which contains a motor. The spin chuck 1 is rotatable about a vertical axis when driven by the chuck rotating mechanism 13. The rotation column 11 and the chuck rotating mechanism 13 are placed inside a casing 2 in a shape of a cylinder. A disk-shaped spin base 15 is linked by a fastening component such as a screw to a top end portion of the rotation column 11 as one integrated unit. The spin base 15 therefore rotates about the vertical axis when driven by the chuck rotating mechanism 13 in response to an operation command received from a control unit 4 which controls the apparatus as a whole. Thus, in this embodiment, the chuck rotating mechanism 13 functions as a “rotator” of the invention.

Plural chuck pins 17 for holding the substrate W at the rim thereof are disposed upright in the vicinity of the rim of the spin base 15. There may be three or more chuck pins 17 to securely hold the disk-shaped substrate W, and the chuck pins 17 are arranged at equal angular intervals along the rim of the spin base 15. Each chuck pin 17 comprises a substrate support part which supports the substrate W at the rim thereof from below and a substrate holding part which presses the substrate W at the outer peripheral edge surface thereof to hold the substrate W. Each chuck pin 17 is structured so as to be capable of switching between a pressing state that the substrate holding part presses the substrate W at the outer peripheral edge surface thereof and a released state that the substrate holding part stays away from the outer peripheral edge surface of the substrate W.

The plural chuck pins 17 are in the released state while the substrate W is being transferred to the spin base 15 but in the pressing state for cleaning of the substrate W. When in the pressing state, the plural chuck pins 17 hold the substrate W at the rim thereof and keep the substrate approximately horizontally at a predetermined distance from the spin base 15. The substrate W is held with its front surface (pattern-formed surface) Wf directed toward above and its back surface Wb toward below. Thus, in this embodiment, the chuck pins 17 functions as a “substrate holder” of the invention.

Further fixed around the casing 2 is a receiver member 21. Cylindrical partition members 23a, 23b and 23c are disposed upright in the receiver member 21. The space between the outer wall of the casing 2 and the inner wall of the partition member 23a defines a first liquid drainage bath 25a, the space between the outer wall of the partition member 23a and the inner wall of the partition member 23b defines a second liquid drainage bath 25b, and the space between the outer wall of the partition member 23b and the inner wall of the partition member 23c defines a third liquid drainage bath 25c.

Vents 27a, 27b and 27c are formed in bottom portions of the first liquid drainage bath 25a, the second liquid drainage bath 25b and the third liquid drainage bath 25c, respectively, and the respective vents are connected to different drains from each other. In this embodiment for instance, the first liquid drainage bath 25a is a bath for collecting the chemical solution after use and links to a collection drain which collects the chemical solution for reuse. Meanwhile, the second liquid drainage bath 25b is a bath for draining the rinsing liquid after use and links to a waste drain which is for disposal. Further, the third liquid drainage bath 25c is a bath for draining the liquid mixture after use and links to a waste drain which is for disposal.

A splash guard 6 is disposed above the respective liquid drainage baths 25a through 25c. The splash guard 6 is arranged so as to surround the substrate W which is held horizontally by the spin chuck 1 and to freely ascend and descend in a direction of a rotation axis (vertical axis) of the spin chuck 1. The shape of the splash guard 6 is approximately rotational-symmetric to the rotation axis of the spin chuck 1. The splash guard 6 comprises three guards 61, 62 and 63 which are arranged from the inward side to the outward side in a radial direction in a concentric layout with respect to the spin chuck 1. The three guards 61, 62 and 63 are progressively lower in this order from the outermost guard 63 to the innermost guard 61, and the top ends of the respective guards 61, 62 and 63 are aligned in the same plane which extends in the vertical direction.

The splash guard 6 is connected with a guard elevating mechanism 65 so that when an elevator driving actuator (which may for instance be an air cylinder) of the guard elevating mechanism 65 operates in response to an operation command from the control unit 4, the splash guard 6 moves up and down relative to the spin chuck 1. In this embodiment, since the splash guard 6 ascends or descends stepwise when driven by the guard elevating mechanism 65, the processing liquid splashing from the rotating substrate W is drained, split into the first through the third liquid drainage baths 25a through 25c.

An upper section of the guard 61 includes a groove-like first guiding part 61a which is open toward inside and is wedge-shaped (V-shaped) in cross section. With the splash guard 6 set to the highest position (which will hereinafter be referred to as the “first height position”) during chemical processing, the chemical solution splashing from the rotating substrate W is caught by the first guiding part 61a and guided into the first liquid drainage bath 25a. Describing this in more specific details, when the splash guard 6 is at the first height position so that the first guiding part 61a surrounds the substrate W which is held by the spin chuck 1, the chemical solution splashing from the rotating substrate W is guided into the first liquid drainage bath 25a via the guard 61.

Meanwhile, an upper section of the guard 62 includes a slanted part 62a which is tilted diagonally upward from the outward side to the inward side in the radial direction. With the splash guard 6 set to a lower position than the first height position (which will hereinafter be referred to as the “second height position”) during rinsing processing, the rinsing liquid splashing from the rotating substrate W is caught by the slanted part 62a and guided into the second liquid drainage bath 25b. To be more specific, when the splash guard 6 is at the second height position so that the slanted part 62a surrounds the substrate W which is held by the spin chuck 1, the rinsing liquid splashing from the rotating substrate W drops between the top end of the guard 61 and the top end of the guard 62 and is accordingly guided into the second liquid drainage bath 25b.

In a similar way, an upper section of the guard 63 includes a slanted part 63a which is tilted diagonally upward from the outward side to the inward side in the radial direction. With the splash guard 6 set to a lower position than the second height position (which will hereinafter be referred to as the “third height position”) during replacing processing, the liquid mixture splashing from the rotating substrate W is caught by the slanted part 63a and guided into the third liquid drainage bath 25c. In more particular words, when the splash guard 6 is at the third height position so that the slanted part 63a surrounds the substrate W which is held by the spin chuck 1, the liquid mixture splashing from the rotating substrate W drops between the top end of the guard 62 and the top end of the guard 63 and is accordingly guided into the third liquid drainage bath 25c.

Further, the splash guard 6 can be set to a lower position than the third height position (hereinafter be referred to as the “retract position”), thereby making the spin chuck 1 project beyond the top end of the splash guard 6 and allowing a substrate transporter (not shown) loads the substrate W yet to be processed onto the spin chuck 1 and receives the processed substrate W from the spin chuck 1.

The chemical solution nozzle 3 is connected with a chemical solution supplying source CS via a chemical solution valve 31. Hence, when the chemical solution valve 31 opens or closes based on a control command from the control unit 4, the chemical solution is pressure-fed from the chemical solution supplying source CS toward the chemical solution nozzle 3, and the chemical solution nozzle 3 discharges the chemical solution. Further, the chemical solution nozzle 3 is connected with a nozzle moving mechanism 33 (FIG. 5). Driven by the nozzle moving mechanism 33 in response to an operation command from the control unit 4, the chemical solution nozzle 3 reciprocally moves between a discharge position which is above the center of rotation of the substrate W and a stand-by position which is off the discharge position to the side.

A liquid supply unit 7, which selectively supplies the rinsing liquid (DIW) and the liquid mixture (DIW+the organic solvent component) to the rinse nozzle 5, is connected with the rinse nozzle 5. The liquid supply unit 7 comprises a cabinet part 70 for generating the liquid mixture (liquid mixture generator) and is capable of pressure-feeding to the rinse nozzle 5 the liquid mixture generated in the cabinet part 70. The liquid supply unit 7 is also capable of pressure-feeding to the rinse nozzle 5 directly DIW as the rinsing liquid. The organic solvent component may be a substance which is dissolved in DIW (whose surface tension is 72 mN/m) and lowers the surface tension, such as isopropyl alcohol (whose surface tension is 21 through 23 mN/m). The organic solvent component is not limited to isopropyl alcohol (IPA), and various types of organic solvent components such as ethyl alcohol and methyl alcohol may instead be used. Further, the organic solvent component is not limited to a liquid, either: vapor of various types of alcohols may be dissolved as the organic solvent component in DIW to thereby prepare the liquid mixture. In this embodiment, the rinse nozzle 5 thus functions as the “liquid supplier” of the invention.

The cabinet part 70 comprises a reservoir tank 72 which holds the liquid mixture of DIW and IPA. The reservoir tank 72 accepts one end of a DIW introducing pipe 73 which is for supplying DIW into inside the reservoir tank 72, and the other end of the DIW introducing pipe 73 is connected via an on-off valve 73a with a DIW supplying source WS which is formed by utilities or the like installed in a plant. Further, a flowmeter 73b is inserted in the DIW introducing pipe 73 and measures the flow rate of DIW which is led to the reservoir tank 72 from the DIW supplying source WS. Based on the flow rate which the flowmeter 73b measures, the control unit 4 controls opening and closing of the on-off valve 73a so that the flow rate of DIW flowing in the DIW introducing pipe 73 would be a target flow rate (target value).

In a similar manner, the reservoir tank 72 accepts one end of an IPA introducing pipe 74 which is for supplying the IPA liquid into inside the reservoir tank 72, and the other end of the IPA introducing pipe 74 is connected via an on-off valve 74a with an IPA supplying source SS. Further, a flowmeter 74b is inserted in the IPA introducing pipe 74 and measures the flow rate of the IPA liquid which is led to the reservoir tank 72 from the IPA supplying source SS. Based on the flow rate which the flowmeter 74b measures, the control unit 4 controls opening and closing of the on-off valve 74a so that the flow rate of the IPA liquid flowing in the IPA introducing pipe 74 would be a target flow rate (target value).

In this embodiment, from a standpoint of effectively preventing destruction of patterns formed on the substrate surface Wf while suppressing consumption amount of IPA, the flow rates of IPA (IPA liquid) and DIW introduced into the reservoir tank 72 are adjusted so that the ratio in volume of IPA to DIW may be 1:9, that is, so that the IPA concentration may be 10%. Thus lowered IPA concentration makes it possible to simplify protection for the apparatus against exposure of IPA as compared to where the IPA concentration is 100%. Further, while it is necessary to execute filtering of the supplied fluid (namely, the liquid mixture) using a filter which will be described later for the purpose of removal of foreign matters, e.g., particles contained in the fluid supplied to the substrate W, when the concentration of IPA is 100%, a problem could arise that removal of foreign matters such as particles contained in IPA will become difficult due to a low surface tension. In contrast, mixing of IPA with DIW is advantageous in making it easy to remove foreign matters contained in the liquid mixture.

The reservoir tank 72 further accepts insertion of the other end of a liquid mixture supplying pipe 75 whose one end is connected with a mixing valve 71, so as to supply the liquid mixture stored in the reservoir tank 72 to the mixing valve 71 via a liquid mixture valve 76. In the liquid mixture supplying pipe 75, a constant rate pump 77 which feeds the liquid mixture stored in the reservoir tank 72 to the liquid mixture supplying pipe 75, a temperature adjuster 78 which adjusts the temperature of the liquid mixture which is pumped out by the constant rate pump 77 into the liquid mixture supplying pipe 75, and a filter 79 which removes foreign matters contained in the liquid mixture. In addition, a concentration meter 80 which monitors the concentration of IPA is inserted in the liquid mixture supplying pipe 75.

Further, one end of a liquid mixture circulation pipe 81 branches out from the liquid mixture supplying pipe 75 between the liquid mixture valve 76 and the concentration meter 80, and the other end of the liquid mixture circulation pipe 81 is connected with the reservoir tank 72. A circulation valve 82 is inserted in the liquid mixture circulation pipe 81. During the operation of the apparatus, the constant rate pump 77 and the temperature adjuster 78 are driven all the time, whereas while the liquid mixture is not supplied to the substrate W, the liquid mixture valve 76 is closed and the circulation valve 82 is opened. In this way, the liquid mixture which is pumped out by the constant rate pump 77 from the reservoir tank 72 returns back to the reservoir tank 72 via the liquid mixture circulation pipe 81. In short, when the liquid mixture is not supplied to the substrate W, the liquid mixture circulates in the circulation path composed of the reservoir tank 72, the liquid mixture supplying pipe 75 and the liquid mixture circulation pipe 81.

Meanwhile, at the timing for supplying the liquid mixture to the substrate W, the liquid mixture valve 76 is opened and the circulation valve 82 is closed. This provides the mixing valve 71 with the liquid mixture which is pumped out from the reservoir tank 72. Further, the mixing valve 71 is connected with the rinse nozzle 5 via a pipe 51 so that the liquid mixture supplied to the mixing valve 71 is discharged toward the substrate W from the rinse nozzle 5.

In this way, by circulating the liquid mixture while it is not supplied to the substrate W, DIW and IPA get agitated, realizing a state that DIW and IPA are adequately mixed with each other. In addition, the temperature of the liquid mixture is adjusted to a predetermined temperature after the liquid mixture valve 76 has opened, and the liquid mixture free from foreign matters is quickly supplied to the rinse nozzle 5.

Further, one end of a DIW supplying pipe 83 branches out from the DIW introducing pipe 73 at the upstream side (that is, at the DIW supplying source WS side) to the on-off valve 73a, and the other end of the DIW supplying pipe 83 is connected with the mixing valve 71. A rinsing liquid valve 84 is inserted in the DIW supplying pipe 83. According to the structure like this, when the valves 76 and 84 are controlled to open and close in response to a control command from the control unit 4, DIW and the liquid mixture (DIW+IPA) are supplied selectively to the rinse nozzle 5. That is, when the liquid mixture valve 76 closes and the rinsing liquid valve 84 opens, DIW is supplied to the rinse nozzle 5 via the mixing valve 71. On the other hand, when the liquid mixture valve 76 opens and the rinsing liquid valve 84 closes, the liquid mixture is supplied to the rinse nozzle 5 via the mixing valve 71.

Further, the nozzle moving mechanism 53 (FIG. 5) is connected with the rinse nozzle 5 so that when the nozzle moving mechanism 53 operates in response to an operation command from the control unit 4, the rinse nozzle 5 reciprocally moves between a discharge position which is above a central section of the substrate W and a stand-by position which is off the discharge position to the side.

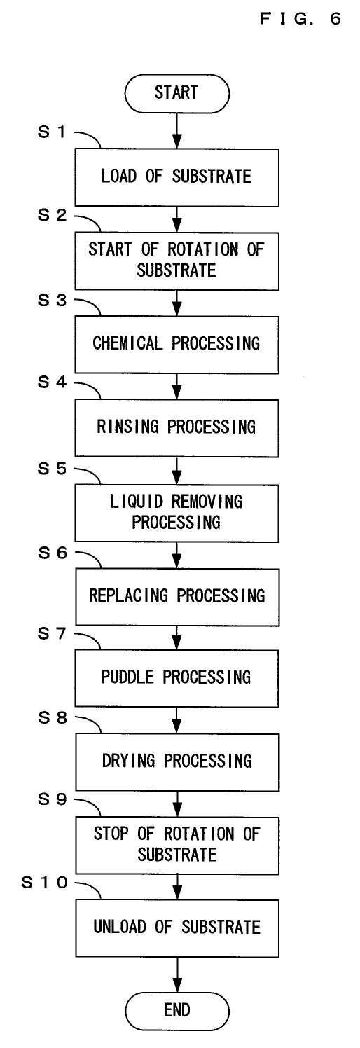

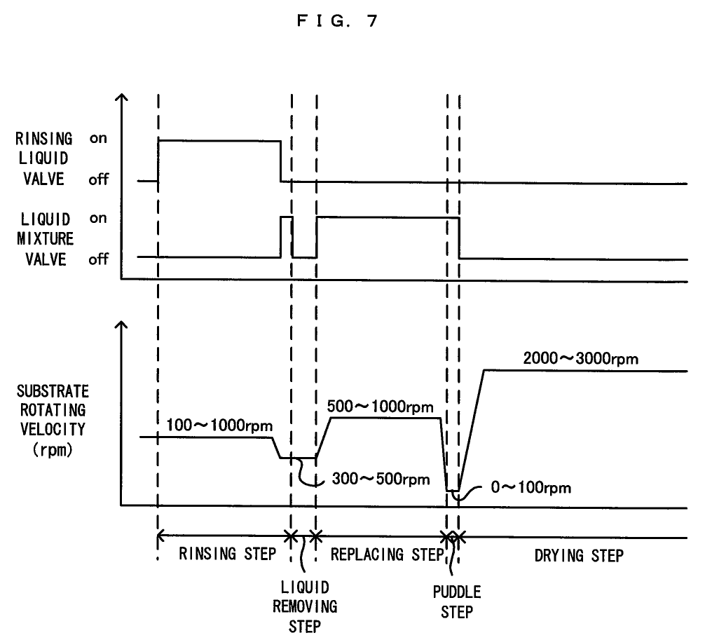

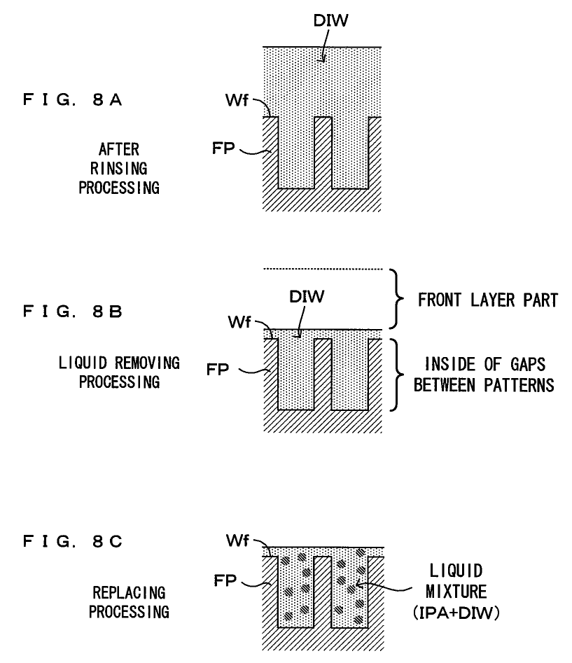

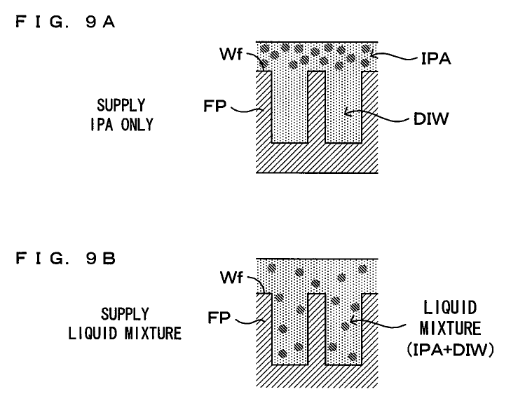

Next, a cleaning processing operation in the substrate processing apparatus structured as described above will now be described with reference to FIGS. 6 through 8. FIG. 6 is a flow chart which shows an operation of the substrate processing apparatus which is shown in FIG. 4. FIG. 7 is a timing chart which shows the operation of the substrate processing apparatus which is shown in FIG. 4. FIGS. 8A through 8C are schematic diagrams which show the operation of the substrate processing apparatus which is shown in FIG. 4.

First, the control unit 4 makes the splash guard 6 position at the retract position and the spin chuck 1 project beyond the top end of the splash guard 6. In this condition, the substrate transporter (not shown) loads the substrate W yet to be processed into inside the apparatus (Step SI), and cleaning processing (chemical processing+rinsing processing+replacing processing+drying processing) of the substrate W is performed. Meanwhile, micro patterns made of poly-Si for example are formed on the substrate surface Wf. Noting this, in this embodiment, the substrate W is loaded into the apparatus with the substrate surface Wf directed toward above and is held by the spin chuck 1.

Following this, the control unit 4 moves the splash guard 6 to the first height position (which is the position shown in FIG. 4), and chemical processing of the substrate W is executed. In other words, the chemical solution nozzle 3 moves to the discharge position, and by driving the chuck rotating mechanism 13, the substrate W held by the spin chuck 1 rotates at a predetermined rotating velocity (which may for example be 500 rpm) (Step S2). The chemical solution valve 31 is then opened, thereby supplying a hydrofluoric acid as the chemical solution to the substrate surface Wf from the chemical solution nozzle 3. The hydrofluoric acid supplied to the substrate surface Wf spreads due to centrifugal force and chemically processes the substrate surface Wf as a whole (Step S3; chemical processing step). The hydrofluoric acid shaken off from the substrate W is guided into the first liquid drainage bath 25a and reused properly.

Upon completion of chemical processing, the chemical solution nozzle 3 moves to the stand-by position. The splash guard 6 then moves to the second height position, and rinsing processing of the substrate W is executed. In short, with the rinse nozzle 5 moved to the discharge position and the rinsing liquid valve 84 opened, the rinsing liquid (DIW) is supplied to the surface Wf of the rotating substrate W from the rinse nozzle 5. This spreads the rinsing liquid due to centrifugal force and the entire substrate surface Wf is consequently rinsed (Step S4; rinsing processing step). As a result, the hydrofluoric acid adhering to the substrate surface Wf is removed by the rinsing liquid off from the substrate surface Wf The rinsing liquid used and drained from the substrate W is guided into the second liquid drainage bath 25b and discharged. Meanwhile, the rotating velocity of the substrate W during rinsing is set to 100 through 1,000 rpm for instance.

Upon completion of rinsing processing, the control unit 4 sets the rotating velocity of the substrate W to 300 through 500 rpm. In addition, the rinsing liquid valve 84 is closed, and the liquid mixture valve 76 is opened only for a predetermined period of time. With this, the rinsing liquid which remains inside the rinse nozzle 5 and the pipe 51 is pushed out by the liquid mixture and is discharged to outside the nozzle. This is followed by closing of the liquid mixture valve 76. Although a relatively large amount of the rinsing liquid stays adhering to thus rinsed substrate surface Wf (FIG. 8A), since the substrate W rotates for the predetermined period of time, the majority of the rinsing liquid on the substrate surface Wf is shaken off and removed from the substrate surface Wf, leaving a part of the rinsing liquid (Step S5; liquid removing step). To be more specific, such a state (front layer removed state) is attained that only a front layer part of the rinsing liquid is removed from the substrate surface Wf and the rinsing liquid inside gaps between micro patterns FP is left staying there (FIG. 8B). As a result, the substrate surface Wf as a whole is coated with a liquid film which is thinner than a liquid film (namely, a liquid film composed of the rinsing liquid) adhering to the substrate surface Wf after rinsing processing. The rotating velocity of the substrate W described above brings about the front layer removed state in a relatively short time while preventing drying of the substrate surface Wf. The execution time of the liquid removing step is therefore set to 0.5 through 1 second for example. This set time prevents partial drying of the substrate surface Wf which will otherwise occur if the execution time is too long and obviates insufficient removal of the rinsing liquid from the substrate surface Wf which will otherwise occur if the execution time is too short. Thus, in this embodiment, the chuck rotating mechanism 13 functions as a “liquid remover” of the invention.

When the liquid removing step thus ends, the control unit 4 sets the rotating velocity of the substrate W to 500 through 1,000 rpm and moves the splash guard 6 to the third height position. The liquid mixture valve 76 then opens, which makes the rinse nozzle 5 discharge the liquid mixture (DIW+IPA). This liquid mixture has been produced in advance so as to have the ratio in volume of IPA to DIW of 1:9 in the cabinet part 70 (liquid mixture producing step), and the rinse nozzle 5 discharges this liquid mixture toward the substrate surface Wf. Meanwhile, since the rinsing liquid remaining inside the rinse nozzle 5 and the pipe 51 after rinsing processing is removed to outside the nozzle prior to the liquid removing step, the rinsing liquid and the liquid mixture will never be supplied one after another to the substrate surface Wf. The liquid mixture supplied to the substrate surface Wf, owing to the absence of the front layer part of the rinsing liquid on the substrate surface Wf, easily enters into even inside the gaps between the patterns. That is, since the front layer part of the rinsing liquid obstructing feeding of the liquid mixture into the gaps between the patterns has already been removed off from the substrate surface Wf, the liquid mixture highly efficiently reaches even inside of the gaps between the patterns. In addition, rotations of the substrate W at the relatively high speed develop centrifugal force which acts upon the liquid mixture and make the liquid mixture flow. This makes it possible for the liquid mixture to enter into even inside the gaps between the patterns at an even better efficiency. In consequence, as shown in FIG. 8C, the liquid component (the rinsing liquid) adhering to the gaps between the micro patterns FP is replaced with the liquid mixture without fail (Step S6; replacing step). The rinsing liquid used and drained from the substrate W is guided into the third liquid drainage bath 25c and disposed.

Following this, while maintaining the liquid mixture valve 76 open, the control unit 4 stops the substrate W from rotating or sets the rotating velocity of the substrate W to 100 rpm or less. By supplying the liquid mixture to the substrate surface Wf in a condition that the substrate W is held still or rotating at a relatively low speed in this way, a puddle-like liquid mixture layer is formed on the entire substrate surface Wf (Step S7). Formation of the puddle-like liquid mixture layer on the substrate surface Wf (puddle processing) suppresses adhesion of particles to the substrate surface Wf.

The control unit 4 thereafter enhances the rotating velocity of the chuck rotating mechanism 13 and makes the substrate W rotate at a high speed (which may for instance be 2,000 through 3,000 rpm). This drains the substrate surface Wf off of the liquid mixture adhering thereto, and drying processing (spin drying) of the substrate W is executed (Step S8; drying step). At this stage, the liquid mixture is present in the gaps between the patterns. It is therefore possible to shorten the drying time and improve the throughput while preventing destruction of the patterns, generation of watermarks, etc. In addition, thus shortened drying time reduces elution of an easily-oxidized substance into the liquid component (liquid mixture) which adheres to the substrate W and further effectively suppresses generation of watermarks. After drying processing of the substrate W ends, the control unit 4 controls the chuck rotating mechanism 13 and stops the substrate W from rotating (Step S9). The control unit 4 then moves the splash guard 6 to the retract position and makes the spin chuck 1 project to above beyond the splash guard 6. The substrate transporter thereafter unloads thus processed substrate W from the apparatus, which completes the series of cleaning processing of one substrate W (Step S10).

As described above, in this embodiment, the majority of the rinsing liquid (DIW) adhering to the substrate surface Wf is removed off from the substrate surface Wf while leaving a part of the rinsing liquid. It is therefore possible to sufficiently dissolve IPA in the liquid component (rinsing liquid) adhering to the inside of the gaps between the patterns. Here, IPA functions as a surface tension reducing substance which is an organic solvent component which gets dissolved in the liquid and reduces the surface tension of the liquid. As a result, the replacement of the liquid component adhering to the inside of the gaps between the patterns with the liquid containing IPA (liquid mixture) is secured, and hence, effective prevention of destruction of the patterns and generation of watermarks during drying of the substrate. Further, since the majority of the rinsing liquid is removed off from the substrate surface Wf prior to replacement with the liquid mixture (replacing step), it is possible to replace the rinsing liquid with a relatively small amount of the liquid mixture and therefore suppress consumption of IPA. Moreover, since it is possible to feed the liquid mixture into the gaps between the patterns efficiently, it is possible to shorten the execution time of the replacing step itself.

In addition, according to this embodiment, since only the rinsing liquid of the front layer part alone is removed off from the substrate surface Wf, it is possible to easily make the liquid mixture reach even to the inside of the gaps between the patterns. It is also possible to prevent partial drying of the substrate surface Wf since the rinsing liquid of the front layer part alone is removed off from the substrate surface Wf while leaving the liquid film on the substrate surface Wf. This prevents pattern destruction at the liquid removing step. Further, it is possible to prevent exposure of the substrate surface Wf to an external atmosphere and suppresses adhesion of particles to the substrate surface Wf.

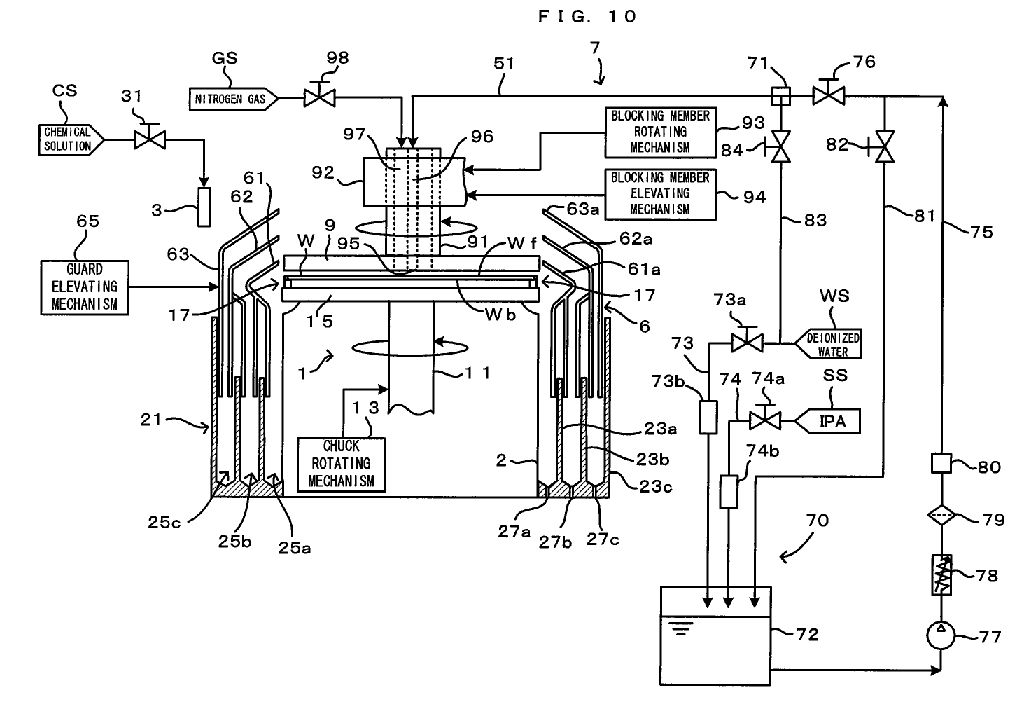

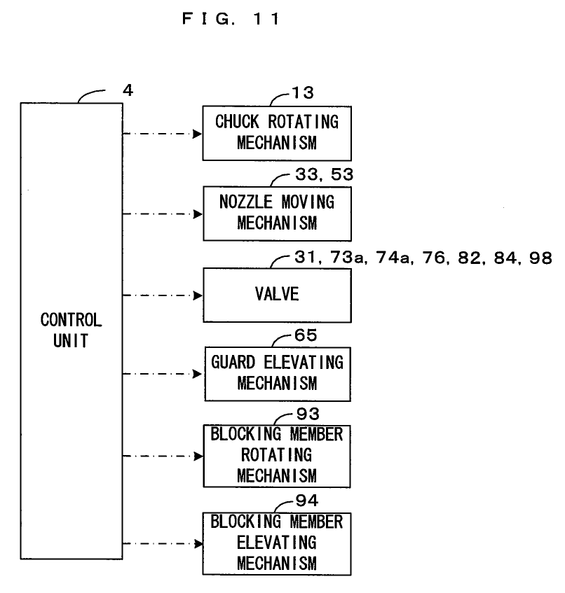

Further, according to this embodiment, since the IPA concentration is 50% or lower, it is possible to efficiently replace DIW adhering to the gaps between the patterns with a substance whose surface tension is smaller than that of DIW. In other words, if DIW adhering to the gaps between the micro patterns FP is to be replaced with IPA (IPA liquid) having the concentration of 100%, a great amount of IPA is necessary and the amount of IPA available for consumption per substrate is restricted from the viewpoint of suppression of a cost increase. However, when the amount of IPA supplied per substrate is reduced, it is difficult to send the surface tension reducing substance (IPA) into the gaps between the micro patterns FP and decrease the surface tension even if it is possible for IPA to get mixed with the front layer part of DIW adhering to the substrate surface Wf, as shown in FIG. 9A for instance.

On the contrary, supply of the liquid mixture in which the IPA concentration is 50% or less to the substrate W replaces the rinsing liquid (DIW) on the substrate with the liquid mixture as shown in FIG. 9B as well as the rinsing liquid adhering to the gaps between the micro patterns FP with the liquid containing the surface tension reducing substance (liquid mixture). It is in this fashion possible to send the surface tension reducing substance into the gaps between the micro patterns FP and reduce the surface tension even without replacing processing which uses IPA (surface tension reducing substance) having the concentration of 100%. In this instance, since the IPA concentration is 50% or below, the amount of IPA present in the gaps between the patterns is less than what would be present in replacing processing which uses IPA having the concentration of 100%. However, as FIG. 1 clearly shows, even when the IPA concentration is beyond 50%, the surface tension of the liquid mixture does not drop considerably, which means that one can not expect a significant reduction of the force destroying the patterns. On the contrary, this will give rise to a more influential disadvantage attributable to a restriction upon the amount of the liquid mixture supplied to the substrate W due to the increased consumption amount of IPA described above. Hence, setting the IPA concentration to 50% or below realizes effective prevention of destruction of the patterns while suppressing the consumption amount of IPA.

In short, according to this embodiment, it is possible to securely replace the liquid component adhering to the gaps between the patterns with the liquid mixture by (1) removing the majority of the rinsing liquid on the substrate surface Wf off from the substrate surface Wf while leaving a part of the rinsing liquid there and (2) using the liquid mixture in which the IPA concentration is 50% or less. That is, the effect of the aspect (1) described above clears the substrate surface Wf of the rinsing liquid which serves as an obstacle against the liquid mixture which is on its way into the gaps between the patterns. On top of this, because of the effect of the aspect (2) described above, it is possible to supply the liquid which contains a relatively large amount of the surface tension reducing substance (IPA) to the substrate surface Wf. It is therefore possible to efficiently replace the liquid component adhering to the gaps between the patterns with the liquid mixture and effectively prevent destruction of the patterns.

Further, as FIG. 3 clearly tells, the force which causes pattern destruction is minimum when the IPA concentration is around 10%. In light of this, for effective prevention of destruction of the patterns while suppressing the consumption amount of IPA, the IPA concentration is preferably 10% or a level around the same as described in relation to this embodiment. In more particular words, it is desirable that the IPA concentration is from 5% to 35% and it is further desirable that the IPA concentration is from 5% to 10%. Where the IPA concentration is set as such, it is possible to enjoy the synergy between the effect of preventing pattern destruction promised by an increased amount of the liquid mixture supplied and the effect of preventing pattern destruction promised by a reduction of the pattern destroying force, and hence, to effectively prevent destruction of the patterns.

### Second Embodiment

FIG. 10 is a diagram showing a second embodiment of a substrate processing apparatus according to the invention.

FIG. 11 is a block diagram which shows a control configuration of the substrate processing apparatus which is shown in FIG. 10. A major difference of the substrate processing apparatus according to the second embodiment from that according to the first embodiment is that a blocking member 9 functioning as the “atmosphere blocker” of the invention is disposed at a position above the spin chuck 1. The other structures and operations are similar to those according to the first embodiment, and therefore, will merely be denoted at the same reference symbols but will not be described.

The blocking member 9 is a disk-shaped member which has an opening in its central section and disposed at a position above the spin chuck 1. A lower surface (bottom surface) of the blocking member 9 is an opposed surface which is opposed and approximately parallel to the substrate surface Wf, and the plane size of the blocking member 9 is equal to or larger than the diameter of the substrate W. The blocking member 9 is attached approximately horizontally to the bottom end of a rotation column 91 which is shaped approximately cylindrical, and an arm 92 extending in the horizontal direction holds the rotation column 91 so that the rotation column 91 can rotate about a vertical axis which penetrates the center of the substrate W. A blocking member rotating mechanism 93 and a blocking member elevating mechanism 94 are connected with the arm 92.

The blocking member rotating mechanism 93 rotates the rotation column 91 about the vertical axis which penetrates the center of the substrate W, in response to an operation command from the control unit 4. Further, the blocking member rotating mechanism 93 is structured so as to rotate the blocking member 9 at the approximately same rotating velocity as the substrate W and in the same rotating direction as the substrate W in accordance with the rotation of the substrate W held by the spin chuck 1.

The blocking member elevating mechanism 94 is capable of moving the blocking member 9 close and opposed to the spin base 15 and moving the blocking member 9 away from the spin base 15 in response to an operation command from the control unit 4. To be more specific, activating the blocking member elevating mechanism 94, the control unit 4 makes the blocking member 9 ascend to a separated position above the spin chuck 1 during loading and unloading of the substrate W into and from the substrate processing apparatus. On the other hand, for predetermined processing of the substrate W, the control unit 4 makes the blocking member 9 descend to a predetermined opposed position (the position shown in FIG. 10) which is very close to the surface Wf of the substrate W which is held by the spin chuck 1. In this embodiment, the blocking member 9 remains at the opposed position from the start of rinsing processing of the substrate W until the end of drying processing of the substrate W.

There is a nozzle 95 in a central section of the blocking member 9. The rotation column 91 is hollow and a liquid supplying pipe 96 is inserted through the rotation column 91. The nozzle 95 is joined to the bottom end of the liquid supplying pipe 96. The liquid supplying pipe 96 is connected with the liquid supply unit 7 via the pipe 51 so that when the liquid supply unit 7 supplies the rinsing liquid and the liquid mixture, the nozzle 95 selectively discharges the rinsing liquid and the liquid mixture. The structure of the liquid supply unit 7 is similar to that according to the first embodiment. In this embodiment, the nozzle 95 thus functions as the “liquid supplier” of the invention.

The gap between the inner wall surface of the rotation column 91 and the outer wall surface of the liquid supplying pipe 96 defines a cylindrical gas supplying path 97. The gas supplying path 97 is connected with a gas supplying source GS via an on-off valve 98 and supplies a nitrogen gas into the space which is formed between the rotation column 91 and the substrate surface Wf. Although a nitrogen gas is supplied from the gas supplying source GS in this embodiment, the gas supplying source GS may supply air, other inert gas or the like. In this embodiment, the gas supplying source GS thus functions as the “gas supplier” of the invention.

In the substrate processing apparatus having such a structure, the substrate W is cleaned in the following manner. That is, the chemical solution nozzle 3 supplies the chemical solution to the substrate surface Wf, whereby chemical processing is executed to the substrate W. Following this, the blocking member 9 is positioned to the opposed position from the separated position and rotates with the rotation of the substrate W. A nitrogen gas is then supplied through the cylindrical gas supplying path 97, which turns the space between the blocking member 9 and the substrate surface Wf into a nitrogen gas atmosphere. Further, the nozzle 95 discharges the rinsing liquid (DIW), thereby rinsing the substrate W (rinsing step). After rinsing processing, by the rotation of the substrate W, the substrate surface Wf is drained off of the front layer part alone of the rinsing liquid which adheres to the substrate surface Wf (liquid removing step).

The nozzle 95 then discharges the liquid mixture (DIW+IPA), which replaces the rinsing liquid adhering to the substrate surface Wf with the liquid mixture (replacing step). Further, with the substrate W kept still or rotating at a relatively low speed, the liquid mixture is supplied to the substrate surface Wf so that a puddle-like liquid mixture layer is formed on the entire substrate surface Wf. When the liquid mixture layer is formed on the substrate surface Wf in this way, the control unit 4 increases the rotation speeds of the motors of the chuck rotating mechanism 13 and the blocking member rotating mechanism 93 and makes the substrate W and the blocking member 9 rotate at high speeds. The substrate surface Wf is consequently drained off of the liquid mixture, which attains drying (spin drying) of the substrate W (drying step). During this drying processing, the space between the blocking member 9 and the substrate surface Wf changes to a nitrogen gas atmosphere, which facilitates drying of the substrate W and shortens the drying time.

As described above, according to this embodiment, in a similar fashion to that according to the first embodiment, the majority of the rinsing liquid adhering to the substrate surface Wf is removed off from the substrate surface Wf while leaving a part of the rinsing liquid before the replacing step. Hence, the liquid component adhering to the inside of the gaps between the patterns is replaced with the liquid mixture without fail, to thereby effectively prevent destruction of the patterns and generation of watermarks during drying of the substrate. Further, since the space which is formed between the blocking member 9 and the substrate surface Wf turns into a nitrogen gas atmosphere, it is possible to reduce the concentration of oxygen in the ambient atmosphere around the substrate W. This makes it possible to reduce elution of an easily-oxidized substance such as Si into the rinsing liquid and the liquid mixture from the substrate surface Wf Hence, it is possible to effectively prevent generation of watermarks on the substrate surface Wf.

### Third Embodiment

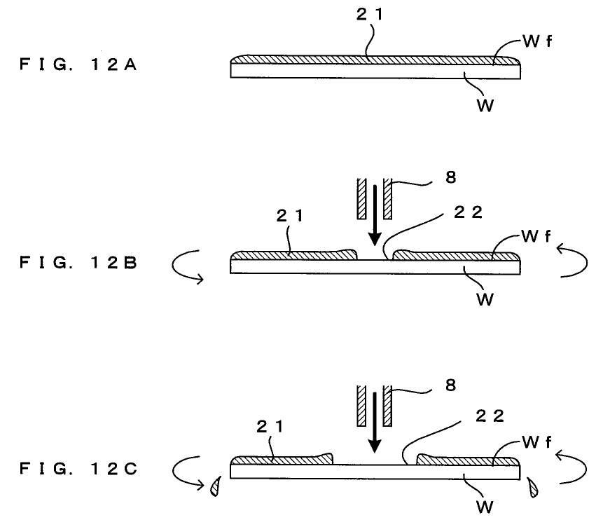

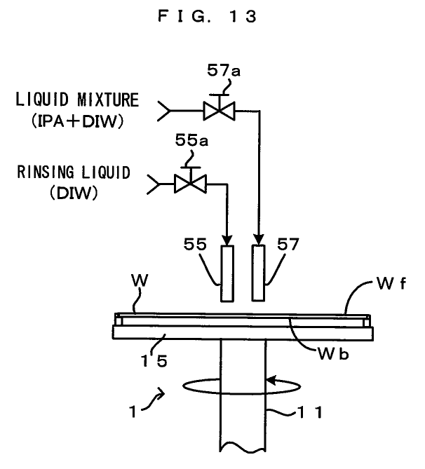

FIGS. 12A, 12B, and 12C are diagrams showing a third embodiment of a substrate processing apparatus according to the invention. A major difference of the substrate processing apparatus according to the third embodiment from that according to the first and second embodiments is that a pre-drying step is executed after the replacing step but before the drying step. The other structures and operations are similar to those according to the second embodiment, and therefore, will merely be denoted at the same reference symbols but will not be described.

In this embodiment, the following pre-drying step is executed after replacement with the liquid mixture (replacing step) but before drying of the substrate W (drying step). First, the liquid mixture is supplied to the substrate surface Wf, and a puddle-like liquid mixture layer 21 is formed all over the substrate surface (FIG. 12A). Following this, a gas discharge nozzle 8 blows a nitrogen gas toward a central section of the surface of the substrate W. At this stage, the substrate W rotates at a low speed (which may for instance be 50 rpm). In consequence, as shown in FIG. 12B, a nitrogen gas blown to the substrate surface Wf from the gas discharge nozzle 8 pushes the liquid mixture present in a central part of the liquid mixture layer 21 toward the outer side in the radial direction of the substrate W, whereby a hole 22 is formed in the central part of the liquid mixture layer 21 and this surface portion is dried.

And, by blowing a nitrogen gas continuously toward a central section of the surface of the substrate W, as shown in FIG. 12C, thus formed hole 22 expands toward the edge of the substrate W (i.e., in the left-right direction in FIG. 12C), the liquid mixture at the center of the liquid mixture layer 21 is gradually pushed away from the center toward the edge of the substrate and the dried region accordingly grows. This achieves removal of the liquid mixture adhering to a central section of the surface of the substrate W without leaving any liquid mixture in the central section of the surface of the substrate W. In this embodiment, the gas discharge nozzle 8 thus functions as the “gas blower” of the invention.

When the pre-drying step finishes in this way, the substrate W rotates at a high speed and drying (spin drying) of the substrate W is performed. At this stage, as in the case of the second embodiment, the blocking member 9 may be moved closer to the substrate surface Wf and the space between the blocking member 9 and the substrate surface Wf may be turned into a nitrogen gas atmosphere. This shortens the drying time and suppresses elution of an easily-oxidized substance.

As described above, according to this embodiment, by executing the pre-drying step described above, it is possible to prevent the liquid mixture from remaining as droplets in the central section of the surface of the substrate W, becoming stripes of particles and forming watermarks on the substrate surface Wf during the drying step. In other words, while the substrate W rotates for removal of the liquid mixture adhering to the substrate surface Wf and drying (spin drying) of the substrate surface Wf, the closer the liquid mixture is to the central section of the surface of the substrate W, less acted upon the liquid mixture is by centrifugal force, and therefore, drying progresses from the edge of the surface of the substrate W. When this occurs, droplets may remain from the central section of the surface of the substrate W to the periphery of the substrate W and run toward the edge of the substrate W and watermarks may be formed on the trails of the moving droplets. On the other hand, according to this embodiment, by forming the hole 22 in the central part of the puddle-like liquid mixture layer 21 which is formed on the substrate surface Wf in advance before the drying step and expanding the hole 22, the liquid mixture which is present in the central section of the surface of the substrate W is removed, and hence, forming of watermarks is securely prevented. In particular, when the IPA concentration is low, the contact angle θ with respect to the substrate surface Wf is larger than when the IPA concentration is 100%, and hence, stripe-like particles, watermarks and the like are likely to be formed. Therefore, execution of the pre-drying step described above is very effective for prevention of stripe-like particles, watermarks and the like.

### Fourth Embodiment

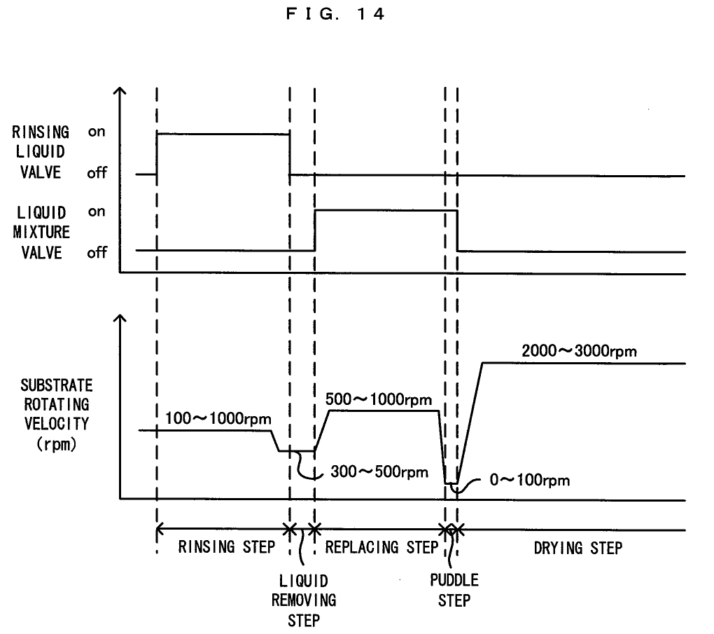

FIG. 13 is a diagram showing a fourth embodiment of a substrate processing apparatus according to the invention. A major difference of the substrate processing apparatus according to the fourth embodiment from that according to the first embodiment is that it permits supply of the rinsing liquid and the liquid mixture individually from different nozzles (liquid suppliers) to the substrate surface Wf, whereas the same liquid supplier (the rinse nozzle 5) supplies the rinsing liquid (DIW) and the liquid mixture (IPA+DIW) to the substrate W according to the first embodiment.

In this embodiment, a rinse nozzle 55 and a liquid mixture nozzle 57 are provided which respectively supply the rinsing liquid and the liquid mixture from above the substrate W which is held by the spin chuck 1. The rinse nozzle 55 is connected with a rinsing liquid supplying source via a rinsing liquid valve 55a, while the liquid mixture nozzle 57 is connected with a liquid mixture supplying source via a liquid mixture valve 57a. Hence, when the rinsing liquid valve 55a and the liquid mixture valve 57a is opened and closed under the control of the control unit 4, the rinse nozzle 55 and the liquid mixture nozzle 57 individually supply the rinsing liquid and the liquid mixture, respectively, toward the substrate surface Wf. Further, a nozzle moving mechanism (not shown) is connected with the rinse nozzle 55 and the liquid mixture nozzle 57 so that when the nozzle moving mechanism operates, the rinse nozzle 55 and the liquid mixture nozzle 57 respectively move between discharge positions above a central section of the surface of the substrate W and stand-by positions which are off the discharge positions to the side. In this embodiment, the liquid mixture nozzle 57 thus functions as the “liquid supplier” of the invention. In this embodiment, the cleaning processing is executed to the substrate W in the following manner.

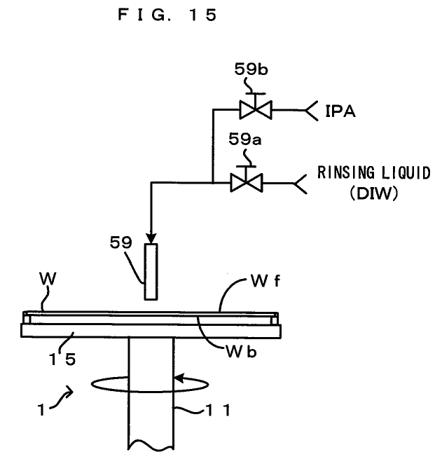

FIG. 14 is a timing chart which shows an operation of the substrate processing apparatus which is shown in FIG. 13. The substrate rotating velocities at the respective steps during cleaning processing are set similar to those in the first embodiment (FIG. 7). After chemical processing, the rinsing liquid valve 55a opens and the rinsing liquid is supplied from the rinse nozzle 55 to the substrate surface Wf. The substrate surface Wf is thus rinsed (rinsing step). After this, the rinsing liquid valve 55a closes and the substrate W rotates at a predetermined rotating velocity (300 to 500 rpm) only for a predetermined period of time (i.e., for approximately 0.5 to 1 second). Thus, the rinsing liquid on the substrate surface Wf is generally shaken off and removed from the substrate surface Wf (liquid removing step). Following this, the liquid mixture valve 57a is opened and the liquid mixture is supplied from the liquid mixture nozzle 57 to the substrate surface Wf Since the front layer part of the rinsing liquid has been removed from the substrate surface Wf, the liquid mixture easily enters into even the inside of the gaps between the patterns and replaces the rinsing liquid adhering to the gaps between the patterns (replacing step). Upon completion of replacement with the liquid mixture, with the liquid mixture valve 57a remaining open, the substrate W stops rotating or slows down to a low rotating velocity (100 rpm or less), thereby forming a puddle-like liquid mixture layer on the substrate surface Wf. The substrate W then rotates at a high speed and is dried (drying step).

As described above, according to this embodiment, in a similar fashion to that according to the first embodiment, the majority of the rinsing liquid adhering to the substrate surface Wf is removed off from the substrate surface Wf while leaving a part of the rinsing liquid before the replacing step. Hence, the liquid component (rinsing liquid) adhering to the inside of the gaps between the patterns is replaced with the liquid mixture without fail, to thereby effectively prevent destruction of the patterns and generation of watermarks during drying of the substrate. Further, the separate nozzles respectively supply the rinsing liquid and the liquid mixture to the substrate surface Wf in this embodiment. This prevents the rinsing liquid and the liquid mixture from remaining respectively inside the liquid mixture nozzle 57 and the rinse nozzle 55. It is unnecessary therefore unlike in the first embodiment to pressure-feed the liquid mixture to the rinse nozzle 5 in an attempt to expel the rinsing liquid remaining inside the rinse nozzle 5 and the pipe 51 to outside the nozzle before the liquid removing step. Hence, the actions during the processing such as opening and closing of the valves are simple, which in turn reduces the amount of the used liquid mixture and further suppress the consumption amount of IPA.

In this embodiment as well, a substrate may be cleaned with the blocking member opposed to the substrate surface Wf as in the second embodiment, in which case two nozzles, one being a rinse nozzle for discharging the rinsing liquid and the other being a liquid mixture nozzle for discharging the liquid mixture, may be disposed to a central section of the blocking member. Further, the pre-drying step may be executed after the replacing step but before the drying step as in the third embodiment.

<Others>

The invention is not limited to the embodiments described above but may be modified in various manners in addition to the embodiments above, to the extent not deviating from the object of the invention. For instance, although after wet processing such as chemical processing and rinsing processing of the substrate W which is held by the spin chuck 1, the substrate W wet with the rinsing liquid is treated by replacing processing and drying processing (spin drying) which use the liquid mixture inside the same apparatus according to the embodiments above, replacing processing and drying processing may be separated from wet processing during execution. Further, replacing processing may be separated from drying processing during execution.

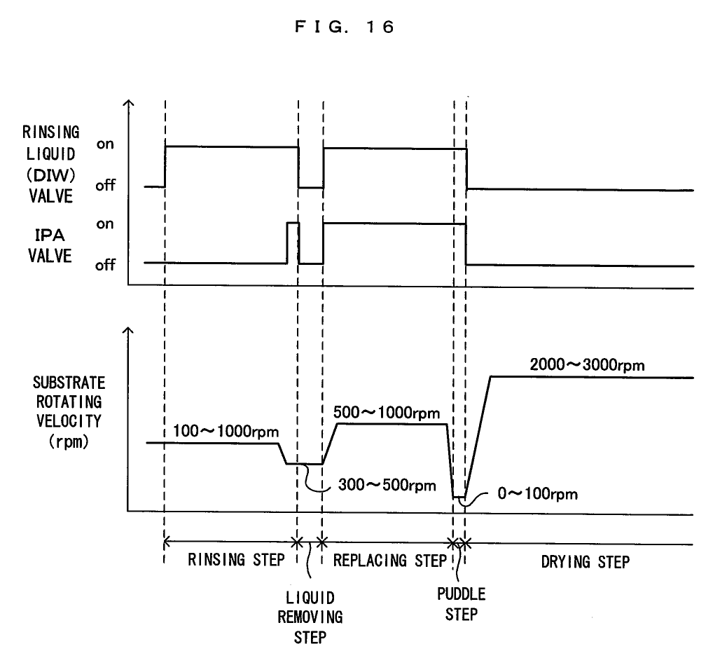

In addition, in the embodiments above, the liquid mixture is generated by mixing the liquid (DIW) with the organic solvent component (IPA) inside the cabinet part 70 which serves as the liquid mixture generator, the liquid mixture generator is not limited to this. For example, as shown in FIG. 15, the organic solvent component may be mixed with the liquid, in an in-line fashion, on a liquid feeder path which is for feeding the liquid toward the liquid supplier such as a nozzle to thereby generate the liquid mixture (Fifth Embodiment).

FIG. 15 is a diagram showing a fifth embodiment of a substrate processing apparatus according to the invention. FIG. 16 is a timing chart which shows the operation of the substrate processing apparatus which is shown in FIG. 15. In this embodiment, a rinse nozzle 59 is connected with a rinsing liquid supplying source via a rinsing liquid valve 59a. Further, at a mixing position on the downstream side to the rinsing liquid valve 59a on a liquid feeder path which links the rinse nozzle 59 to the rinsing liquid supplying source, connection with an IPA supplying source is provided via an IPA valve 59b. In this structure, when the IPA valve 59b closes and the rinsing liquid valve 59a opens, the rinsing liquid (DIW) is supplied to the rinse nozzle 59. Meanwhile, when the rinsing liquid valve 59a and the IPA valve 59b are opened, IPA is mixed with DIW at the mixing position and the liquid mixture (IPA+DIW) is supplied to the rinse nozzle 59. The other structures and operations are similar to those according to the first embodiment, and therefore, differences will now be primarily described.

In this embodiment, as shown in FIG. 16, for supplying the liquid mixture to the rinse nozzle 59, both the rinsing liquid valve 59a and the IPA valve 59b open. In other words, in the last part of the rinsing step, for the purpose of ejecting the rinsing liquid (DIW) remaining inside the rinse nozzle 59 and the liquid feeder path (which is a pipe located on the downstream side to the rinsing liquid valve 59a) to outside the nozzle, the IPA valve 59b opens in addition to the rinsing liquid valve 59a and the liquid mixture is consequently supplied to the rinse nozzle 59. This makes it possible for the rinse nozzle 59 to discharge the liquid mixture during execution of the replacing step after the liquid removing step without discharging the rinsing liquid (which is DIW alone). According to this embodiment therefore, it is possible to clean the substrate W in a similar manner to that according to the first embodiment and obtain similar effects to those according to the first embodiment.

Further, the liquid mixture generator may not necessarily be disposed inside the substrate processing apparatus. The liquid mixture generated in other apparatus which is disposed separately from the substrate processing apparatus may be supplied to the substrate surface Wf via a liquid supplier which is disposed inside the substrate processing apparatus.

Further, in the embodiments above, although the liquid (rinsing liquid) which adheres to the substrate surface Wf is drained off from the substrate surface Wf while rotating the substrate W, the method of removing the liquid is not limited to this. For instance, a gas may be blown toward the liquid which adheres to the substrate surface Wf to thereby remove the majority of the liquid while leaving a part of the liquid. Alternatively, a scraper member such as a squeegee may be disposed at a height position which is away by a predetermined distance from the substrate surface Wf, and while moving the scraper member and the substrate W relative to each other, the scraper member may scrape off and remove the front layer part of the liquid adhering to the substrate surface Wf from the substrate surface Wf.

Further, while the embodiments above use a hydrofluoric acid as the chemical solution, BHF (buffered hydrofluoric acid) may be used for processing.

Further, in the embodiments above, although the substrate surface Wf which is wet with the rinsing liquid is dried, the invention is applicable also to a substrate processing method and a substrate processing apparatus which dry the substrate surface Wf which is wet with other liquid than the rinsing liquid.

Further, although the embodiments above use DIW as the rinsing liquid, the rinsing liquid may be a liquid which contains a component which does not exert a chemical cleaning effect upon the substrate surface Wf such as carbonated water (DIW+CO₂). In such an instance, the liquid mixture obtained by mixing the organic solvent component with a liquid (carbonated water) whose composition is the same as that of the rinsing liquid adhering to the substrate surface Wf may be used. Alternatively, the liquid mixture may be a mixture of the organic solvent component and DIW which is a principal component of carbonated water, while using carbonated water as the rinsing liquid. In essence, the liquid mixture may be a mixture of the organic solvent component and a liquid whose principal component is the same as that of the liquid adhering to the substrate surface Wf. Further, the rinsing liquid may be, other than DIW and carbonated water, hydrogen water, diluted ammonia water (having the concentration of around 1 ppm for instance), hydrochloric acid, or the like.

The present invention is applicable to a substrate processing apparatus and a substrate processing method which performs drying processing to a surface of substrates in general including semiconductor wafers, glass substrates for photomasks, glass substrates for liquid crystal displays, glass substrates for plasma displays and substrates for optical discs.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A substrate processing method of drying a substrate surface which is wet with a liquid, the method comprising:
a liquid removing step of removing a majority of the liquid adhering to the substrate surface from the substrate surface, leaving a part of the liquid;
a replacing step of supplying a liquid mixture which is a mixture of a liquid, whose composition or principal component is the same as that of the liquid adhering to the substrate surface, and an organic solvent component which gets dissolved in the liquid and reduces the surface tension, to the surface of the substrate which is held approximately horizontally, thereby replacing a liquid component still remaining on the substrate surface even after the liquid removing step with the liquid mixture; and
a drying step of removing the liquid mixture from the substrate surface after the replacing step and accordingly drying the substrate surface, wherein
a percentage by volume of the organic solvent component contained in the liquid mixture is 50% or less.

2. The substrate processing method of claim 1, wherein at the liquid removing step, only a front layer part of the liquid adhering to the substrate surface is removed from the substrate surface.

3. The substrate processing method of claim 1, wherein at the liquid removing step, the liquid which adheres to the substrate surface is drained off from the substrate surface while the substrate is rotating.

4. The substrate processing method of claim 3, wherein the rotating velocity of the substrate at the liquid removing step is 300 to 500 rpm.

5. The substrate processing method of claim 3, wherein the duration of execution of the liquid removing step is 0.5 to 1 second.

6. The substrate processing method of claim 1, wherein the percentage by volume of the organic solvent component contained in the liquid mixture is from 5% to 35%.

7. The substrate processing method of claim 6, wherein the percentage by volume of the organic solvent component contained in the liquid mixture is 10% or less.

8. The substrate processing method of claim 1, wherein at the replacing step, the liquid mixture is supplied to the substrate surface while rotating the substrate.

9. The substrate processing method of claim 1, further comprising a rinsing step of supplying a rinsing liquid to the substrate surface and accordingly performing a rinsing processing before the liquid removing step, wherein
the rinsing liquid adhering to the substrate surface after the rinsing step is the liquid adhering to the substrate surface, and the substrate surface which is wet with the rinsing liquid is dried.

10. The substrate processing method of claim 9, wherein the liquid removing step is executed continuously from the end of the rinsing step to the start of the replacing step.

11. The substrate processing method of claim 9, further comprising a chemical processing step of supplying a chemical solution to the substrate surface and accordingly performing a chemical processing before the rinsing step, wherein
at the rinsing step, the chemical solution which remains adhering to the substrate surface is removed from the substrate surface.

12. The substrate processing method of claim 1, wherein the drying step is performed in an inert gas atmosphere.

13. The substrate processing method of claim 1, further comprising a pre-drying processing step executed after the replacing step but before the drying step, wherein
at the drying step, the liquid mixture adhering to the substrate surface is drained off by rotating the substrate, whereby the substrate surface is dried, and
at the pre-drying processing step, a puddle-like liquid mixture layer composed of the liquid mixture is formed all over the substrate surface, and a gas is blown toward a central section of the substrate surface, thereby forming a hole in a central section of the liquid mixture layer and enlarging the hole toward the periphery edge of the substrate.

14. A substrate processing apparatus, comprising:
a substrate holder which holds a substrate approximately horizontally in a condition that a substrate surface which is wet with a liquid is directed toward above;
a liquid supplier which supplies to the surface of the substrate which is held by the substrate holder a liquid mixture which is a mixture of a liquid, whose composition or principal component is the same as that of a liquid adhering to the substrate surface, and an organic solvent component which gets dissolved in the liquid and reduces the surface tension; and
a liquid remover which removes a majority of the liquid adhering to the substrate surface from the substrate surface, leaving a part of the liquid, wherein
after the liquid is removed from the substrate surface by the liquid remover, the liquid supplier supplies to the substrate surface the liquid mixture in which a percentage by volume of the organic solvent component is 50% or less, thereby replacing a liquid component adhering to the substrate surface with the liquid mixture, then the liquid mixture is removed from the substrate surface and accordingly the substrate surface is dried.

15. The substrate processing apparatus of claim 14, further comprising a rotator which rotates the substrate which is held by the substrate holder, wherein
the rotator serves as the liquid remover and drains off the liquid adhering to the substrate surface from the substrate surface while rotating the substrate.

16. The substrate processing apparatus of claim 14, further comprising:
an atmosphere blocker which is disposed above the substrate and is spaced apart from the substrate surface while opposed to the substrate surface; and
a gas supplier which supplies an inert gas to a space which is formed between the atmosphere blocker and the substrate surface.

17. The substrate processing apparatus of claim 15, in which the liquid mixture is drained off from the substrate surface and accordingly the substrate is dried while rotating the substrate by the rotator, the apparatus further comprising a gas blower which blows a gas toward a central section of the surface of the substrate which is held by the substrate holder, wherein
after replacing the liquid component with the liquid mixture but before drying the substrate surface, the liquid supplier supplies the liquid mixture to the substrate surface to form a puddle-like liquid mixture layer with the liquid mixture all over the substrate surface, and then the gas blower blows the gas toward the central section of the substrate surface to form a hole in a central section of the liquid mixture layer and to enlarge the hole toward the periphery edge of the substrate.
